(19) United States
(12) Patent Application Publication
(10) Pub. No.: US 2026/0198732 A1
(43) Pub. Date: Jul. 16, 2026

(54) CAMPFIRE ROASTING FORK ATTACHMENT HEAD AND ITS USE

(71) Applicant: Steen Hjort, Ballerup (DK)

(72) Inventor: Steen Hjort, Ballerup (DK)

(21) Appl. No.: 19/136,248

(22) PCT Filed: Nov. 29, 2023
(86) PCT No.: PCT/DK2023/050290

§ 371 Date: Jun. 5, 2025

(30) Foreign Application Priority Data
Dec. 5, 2022 (DK) PA202201096
Apr. 11, 2023 (DK) PA202300315

(51) Int. Cl. A47J 43/18; A47J 33/00; A47J 37/04; A47J 37/07

(52) U.S. Cl. CPC A47J 43/18; A47J 33/00; A47J 37/04; A47J 37/07

(57) ABSTRACT

The invention relates to a campfire roasting fork, in the form of a campfire roasting fork attachment head (3) with two or more prongs (1) and a shaft connector element (2) which have a square tubular interior and thereby being able to be mounted on or with an arbitrary but suitable shaft (handle part) without necessary use of tool or a fastening device.

### FIELD OF THE INVENTION

The invention relates to a cookware meant for use in relation with food preparation over an open fire in an outdoor fireplace, i.e. a campfire cookware. More specifically the invention relates to a campfire cookware attachment head of the type roasting fork whit two or more prongs and where an important component is a shaft connector element with a square tubular interior for inserting and fixation of an arbitrary but suitable shaft without the use of tool or a fastening device (The Stone-Deer Principle).

### BACKGROUND OF THE INVENTION

The need to prepare food and to boil water for hot drinks or to heat/boil other liquids over an open fire, outdoors, e.g. at a campfire or a fire pit where wood or charcoal is fired, is today sought to be covered using traditional cookware and tools such as; portable grill grates, frying pans, pots, kettles, fish holders, tripods, grate baskets and cages to be mounted on a shaft, round spears with one or more tips either as a single blade roaster or as a fork shaped roaster, all intended to be mounted on a shaft. These types of cooking equipment have certain limitations because they individually may either be targeted to handle specific types of food or being dependent on another specific tool or specific shaft for use, and as a result, alone or in total they can be either heavy, long and/or generally difficult or impractical to handle during transport, during use or during cleaning after use.

Most of these cookware and tools are manufactured as either a complete unit, where a further separation into smaller parts, e.g. to facilitate easier transport or cleaning, is either not possible or difficult, or with a specific divisible shaft. As a consequence of this, a replacement, for example, of a damaged shaft or handle belonging to the individual unit will therefore be either impossible or extremely difficult or economically relatively expensive.

There are transportable grill grates, some of the disadvantage to these are; they are difficult to clean after use, in addition, tongs are required to handle the food, so that you can avoid being burned if the food has to be turned during roasting or removed from the grate after finishing preparation. Transportable grill grates will also often be relatively heavy and relatively large, which makes transport difficult, or if it is a lightweight collapsible grill grate, then its smaller size will not be suitable for use with a pan, a pot or a kettle.

There are frying pans with a shaft/handle section typically in the range of 15-30 cm, the shaft/handle can be either an integrated part or a detachable part. A frying pan most often require either a stand or a grill grate in order to be used as a stable cookware, in addition there are frying pans with a long shaft intended to be held or supported by the hands during use, common to all of them is that they often are heavy and/or relatively large due to the shaft/handle, which makes them difficult to handle during transport to and from an outdoor fireplace.

There are pots that have either one or two handles and are intended for use with a grill grate or a stand, and pots with a foldable handle that are intended for hanging on a rack by a chain. And this dependent relationship means that pots in total often are relatively difficult to handle during transport.

There are kettles, all of which are designed to either be placed on a grill grate, a stand or to be hung in a rack over the campfire during use. And this dependency means that it is often relatively difficult to provide boiled water for hot drinks over a campfire due to the dependency of another tool which in total can be difficult to handle during transport.

There are fish holders which have a relatively short handle and therefore are intended for use with a grill grate or a stand. These fish holders are often relatively large, which overall means that they are difficult to handle during transport.

There are tripods as a complete unit or as a portable bracket plate for building a tripod with branches of wood. The complete tripods are difficult to handle during transport due to size or weight. The portable bracket plate requires three branches of the same length. Tripods are meant to be a rack to hold campfire cookware.

Common to most of the campfire cookware and tools mentioned so far are; when using cookware and tools with a relatively short handle on a grill grate, a stand or with a tripod you are then at time often squatting close to the fire and your face and hands are potentially at risk of being too exposed to smoke and heat. The squatting can also be inconvenient to the knees and your back.

There are grate cages/baskets on a shaft either as a complete unit or as an attachment to be mounted on a specific shaft. These grate cages/baskets are often relatively large or heavy due to the shaft, which overall means that they are difficult to handle during transport.

There are campfire roasting spits and forks with one or more tips either as a complete unit or as a specific shaft with an attachment to be mounted on the specific shaft. These spits and forks are often relatively large or heavy due to the specific shaft, which overall means that they often are difficult to handle during transport.

There are a couple of frying pans where an arbitrary but suitable wooden shaft can be mounted either as an extension of a short handle due to a round tube interior or as a direct shaft/handle part due to a connector element whit a round or cone shaped tube. It requires most often modification with a knife and the use of a fastening device to make these type of pans stable under use with an arbitrary shaft.

And there are fork campfire cookware attachments to be mounted on an arbitrary but suitable wooden shaft with approx. 15-18 mm dia. as a maximum dia. These attachments heads are often relatively flimsy either in their construction or in use when mounted on a shaft whit that size dia. and their prongs are shaped without function as barbs and are relatively short in length.

Common to most of the campfire cookware to be used with a shaft mentioned so far are; they are most often targeted to handle specific types of food and more than one type of cookware is therefore required if a variety of food items are to be cooked.
There are thus significant limitations and/or disadvantages to the existing campfire cookware and tools, and thus the need for the development of a new type/design.

### PRIOR ART

a) Utility stick [US 20150223636A1] describes in this context a multi campfire cookware consisting of a specific round shaft in several parts (preferred material; aluminum), where each part has a specific threaded male ferrule in one end. On the shaft you can mount e.g. different types of attachments, which, as their names in the patent suggest, are targeted to handle specific types of food and are called, for example, 1) wiener stick, 2) marshmallow stick, 3) toaster tray, 4) popsicle pizza, 5) popcorn basket and these attachments each have the corresponding female ferrule with the internal thread at one end of a connecting element, and can then be attached to the specific shaft, one at a time. The connecting element consists of a piece of metal that has a hexagonal prism shape and where the specific female threaded ferrule is inside one end for mounting on the specific shaft.
b) Spit rod assembly and accessory therefor [US2019082883A1] describe a Rotisserie BBQ Square Spit Fork, consisting of a square spit rod made of metal and a pair of rotisserie spit meat forks or what in this context could be described as an identical pair of roasting fork attachment heads, which are intended to be mounted on the spit rod and thereby to be able to fixate a larger piece of meat e.g. a chicken or a roast. The spit with the two meat forks/two roasting fork attachment heads is meant to be placed in a rack over an open fire. The pair of meat forks/roasting fork attachment heads consists each of 2 or more prongs connected to what is described as a hub with an approx. square tubular interior, where three of the tubular interior sides are regular sides and together forms an u-shaped channel and where the largest part of the fourth side is a rectangular locking member, fasten in a pivot joint. The prongs protrudes from the side of the hub and are then bent at a specific distance from the center of the hub at approx. 90 degrees so they then are approx. parallel to the longitudinal direction of the tube for the remaining part of the prongs and they are approx. pointing in the same direction. Determined from the figures in the patent, the prongs are of the type blades and are approx. rectangular in cross-section and with a sort of tapering in the longitudinal direction of the prongs, where the prongs are a bit wider in the end fastened to the hub, and the material thickness can be estimated from the size of the inner approx. squared tube (16×16 mm) to have a material thickness of approx. 5×8 mm, and the distance between the prongs can also be determined based on the size of the inner square tube (16×16 mm) to be 4-6× larger than the interior sides of the square, i.e. 60-100 mm.

As a possible inspiration from this patent, there are a number of different rotisserie spit forks in the general trade today, which have some dimensions as being similar with those mentioned in this specific patent or as seen in the figures of this specific patent. In particular the prongs of the meat forks are quite similar regarding dimensions and when looking at the various rotisserie spits which have an approx. squared tube interior in the relevant size in the range 12×12-24×24 mm, they all have a material thickness of 6-8 mm in general, and the prongs are attached to the outside of the tube part and they are placed and attached across the longitudinal direction of the tube and then bended approx. 90 degrees to make the prongs approx. parallel on the outer parts. The prongs do also have a similar mutual distance that is typically in the range of 80-150 mm on the outer parts of the prongs. And all rotisserie meat forks (roasting fork attachments head) of this type, a fastening device is added to be able to fasten the meat fork to the spit and thereby locking the meat in place when roasting.

Rotisserie spits with these sizes of spits and meat forks are typically intended to be able to handle meat types like whole chickens, briskets, pork roast, beef fillet, goose, duck, turkey with a weight of 1-8 kg and the larger of the spits can even handle a whole piglet of 30 kg.
c) Rondack campfire fork, sold on the internet by; Rawrutes.com

Is a campfire roasting fork (head) made of stainless steel and consists of a fork part with two prongs connected by welding to a shaft connector element. On the Rawrutes.com webside there are some stated measurements for the campfire fork; 111.1 mm L×31.8 mm H×25.4 mm W (4.375 in L×1.25 in H×1 in W).

The shaft connector element is a piece of square profile tube with a fastening device connected by welding to one of the sides in the form of a nut with a hole through the sidewall of the tube, where a bolt with a specific thread can be screwed into the tube and thereby pressing against a wooden shaft inserted in the tube of the shaft connector element.

The prong part is placed and connected on one side of the shaft connector element. And the prong part has a uniform material thickness in its longitudinal direction and can best be described as being the outer fork part of a carving fork, where each of the two prongs are tapering towards the tips of the prongs with each of the prongs being significant wider at their inner parts closest to the shaft connector element. And based on the images of the Rondack campfire fork and the stated measurements, the material thickness of the prongs can be estimated to be approx. the same as the material thickness of the side walls of the shaft connector element, which typically is in the range 1-2 mm on this size of tube.

### DISADVANTAGES OF THE PRIOR ART

a) The multi campfire cookware with its different attachments and the specific shaft can in total be difficult to transport both in terms of weight and volume, and when the shaft and the attachments each having a specific ferrule, a new/extra specific shaft is then required if to be able to use more than one of the attachments at a time or the shaft is damaged. And each of the attachments is targeted to primarily being able to handle specific types of food.
b) The rotisserie spit itself can only with a high degree of difficulty be used handheld during roasting, so in this context, then the accessory meat forks (roasting fork attachments heads) is the relevant to take in to consideration and look at. Due to the size, the width and weight of a single meat fork, it can be difficult to transport. And the weight of the meat fork can also be a disadvantage when mounted on a wooden shaft and handheld during roasting of a food item.

The distance between the prongs and the material thickness of the prongs makes it hard to get most common food items fixated on the prongs for example, an ordinary wiener is most likely to split when it is tried to be fixated on prongs of this size, and therefore larger pieces of food is required. And the combined weight of the roasting fork head and the most often required larger food item, will definitely contribute to making the mentioned disadvantage regarding the handheld roasting, even bigger.

And the lack of some kind of barbs and the relatively thick prongs will makes it difficult not to have a high risk of a food item to slide of the prongs during roasting.
c) The Rondack campfire fork with its tapered prongs can have difficulties regarding to retaining food items on the prongs when roasting, especially if the prongs are not held horizontally or upwards but just slightly is pointed downwards, there would be a high risk of a food item to slide of the prongs.

And the tapering prongs will also have a higher risk of causing a food item to crack during roasting, which can cause the food to fall off, this compared to prongs without tapering.

The fastening device can be difficult to tighten with hands alone and tools may be necessary to use to secure the roasting fork sufficiently to the shaft to be stable during use.

There is a risk of damaging the tread in the nut or on the bolt, which can make it more difficult or impossible to tighten the bolt. And there is a risk of losing the bolt e.g. under transport.

With the prongs placed on just one side of the connector element and not centered around the middle, there will be a certain degree of imbalance in the roasting fork during use, which can be impractical e.g. if the roasting fork is placed against a fire pit boulder during roasting, there will then be a risk for the roasting fork to roll down from the boulder.

### OBJECT OF THE INVENTION

When regarding the disadvantages mentioned in the previous sections, including disadvantages of the prior art, then an object of the invention can be described as partly to provide a new type or a new design of a shaft connector element to be integrated into different types of campfire cookware, which alleviates one or more of the disadvantages that are/may be in known technique and the prior art. And partly to provide a new design of cookware with this shaft connector element as an integrated part, which alleviates one or more of the disadvantages that may be in connection with the use of known technique and the prior art. In particular, it can be seen as an aim to produce; a simply constructed and thus robust, light and affordable campfire cookware with a long lifespan without significant maintenance.

The purpose is fulfilled as described by the accompanying claims. Specifically, it can be described that the size and weight of the new design of the campfire cooking equipment shaft connector element according to the invention, makes the shaft connector element relevant to use as an integrated part not just with a campfire roasting fork attachment head with two or more prongs but with many types of campfire cookware e.g. a frying pan without compromising these regarding to weight or volume during transport or the handling in general when in use.

And the simple and robust design of the new campfire roasting fork attachment head makes it easy to handle during cleaning. The fact that the preferred material for the campfire roasting fork attachment head is steel means that it is very robust and that it has a long service life without significant maintenance. The simple design according to the invention and the material means that it is affordable. In addition, the square/approximately square interior tube part of the connector element makes it easy to assemble/disassemble and to attach to an arbitrary but suitable shaft, this with an optional length, if necessary by any means of a minor adjustment, e.g. made with a knife, of the dimensions of the shaft in the end where to be inserted. And it is an optional possibility to drill a small hole in one of the sides of the tube to thereby being able to insert a fastening device e.g. a screw, if a shaft is chosen to be mounted for long term use.

Overall, the provision of a Campfire cookware attachment head according to the invention will therefore be able to make transport a lot easier regarding the weight and volume partly because a shaft most of the time is no longer necessary to bring along and partly because the new design of a campfire roasting fork attachment head can be more versatile in use and thereby eliminate the need of many other types of roasting cookware.

The new design of a campfire roasting fork attachment head will make it much easier e.g. to provide hot water to drink, this by eliminate the need of a most often larger and heavier stand, rack or tripod to hold the kettle or pot when heating the water. And specifically, it can be described that the size of the new Campfire cookware attachment head according to the invention with a length of less than 40 cm and the weight of less than 125 grams makes it relatively easy to handle during transport and use.

In addition, that the connector element is chosen to have a square prism-shaped exterior according to the invention, has the meaning qua the large single surface on the four sides, that the Campfire cookware during use if placed leaning on a fire pit boulder surrounding the campfire, partly cannot turn around as a result of gravity or impact and puffs or other types of accidental impact, and partly that a food item therefore can be roasted on four sides without further ado. That a food item can be roasted on four sides means a greater and improved taste experience and greater food safety in relation to the antibacterial core temperature of the roasted food.

Finally, the specific design of the prongs and of the square prism-shaped exterior of the connector element, in combination with each other, means that the campfire cookware becomes very versatile in relation to different types of food items that can be prepared with it.

The common types of wieners, carved meat and square prism-shaped cuts of meat, and the common types of bread e.g. flute, buns, etc., as well as vegetables, pieces of fruit and e.g. marshmallows which all usually are prepared by roasting or heating over an open fire, can easily be prepared with this new designed roasting fork. In addition, the utensil can handle e.g. chicken thighs, spareribs and fish with a backbone in portion sizes, as the mutual distance between the two prongs allows the bone inside the meat or the backbone of the fish to slide in between the prongs and thus the piece of meat/fish is effectively held during cooking. Furthermore, the utensil can handle e.g. pieces of pizza, whole pita bread, hash browns, slices of bread and waffles, e.g. Belgian waffles, as these can be slid in between the fork prongs, where the piece of food is then held by a squeezing force between the prongs. Furthermore, the utensil can be used for different types of bread dough and other types of dough with a similar consistency as well as rolls of fresh minced meat in portion sizes, this qua the dimensions of the two prongs and their mutual distance, which ensure sufficient retention force during cooking. An additional advantage is that the utensil can be used to hold a small sized kettle, for boiling water or a small sized hanging pot for boiling or heating food, over the open fire by placing the handle of the kettle/pot between the two prongs and slide it all the way down until it rests against the square-prism shaped part of the head, and that the campfire roasting fork is then supported close to the head or held in the hands, while heating.

And with the use of an arbitrary but suitable shaft with an optional length, issues with smoke and heat can become less due to the choice of a longer shaft. The choice of an arbitrary wooden shaft, where it is possible to choose a shaft that is more likely to be of a length or shape according to the needs of the individual user, can also reduce discomfort in general a given user could have with a factory made shaft.

Overall, the provision of a campfire cookware attachment head according to the invention will in itself alone be able to cover a large part of the need for the preparation and cooking of different types of food, where with traditional Campfire cooking equipment including the prior art, it so far has been necessary to use 2, 3 or 4 different types of equipment to be able to prepare the same variety of food.

### DETAILED DESCRIPTION OF THE INVENTION

Basic experimental development, prototype production and testing

During the development of the invention, a number of prototypes in stainless steel have been produced, but carbon steel could be considered as an alternative, where the focus has been on both the dimensions and the shapes of the material used and the spaciousness, as these were considered to be able to make a significant difference.

### Focus Points

1) The shaft connector element
   A) Round tube interior vs square tube interior.
   B) The material thickness of the square tube.
   C) The size of the interior square of the tube profile.
   D) The length of the square tube.
2) A campfire spear attachment head with one tip.
   E) The dimensions of the hook
3) A campfire roasting fork attachment head with two or more prongs.
   F) Round tube profile exterior vs square tube profile exterior.
   G) Thickness of the prongs.
   H) Length of the prongs.
   I) The mutual distance between the pongs on their parallel part.
   J) The shape of the prong's tips in order to achieve an effect similar to barbs.
   K) The number of prongs.
   L) Attachment point of the fork's prongs.
4) Shaft connecting method; an arbitrary but suitable shaft vs the Campfire cooking equipment shaft connector element;
   M) Retaining force, testing of the Stone-Deer Principle

### 1.A)

During the development process of the invention there was a focus on a round tube profile vs a square tube profile according to which type is most advantageous compared to be mounted on an arbitrary but suitable shaft, branches of hazel and birch were being used for this purpose. Regarding the round tube profile, it was during test quickly determined that it was necessary both to modify the tip of the branch used as shaft, with a knife and to use a sort of fastener e.g. a nail or a screw to ensure adequate retention of the connector element to the shaft when in use. The square tube profile could on the other hand be mounted and fixed stably on a branch of hazel or birch without the use of a fastener or without the need to modify the tip of the branch with a knife. The possibility of using an arbitrary but suitable branch is present because, it is taken advantage of the fact that the diagonal of the square tube is larger than the square sides and thus a branch of wood often is slightly oval in cross-sectional profile or is having a small side branch collar or a curvature that could be chosen to be near the tip of the branch to be inserted into the profile tube. And when inserted then done with the widest part of the branch, the side branch collar or the curvature in the diagonal and then twisted 30-45 degrees horizontally around inside the square tube and thereby get fixed by friction (the Stone-Deer principle).

### 1.B)

During the development process of the invention 4 different sizes of material thickness of the square tube have been tested in terms of robustness and dimensional stability; 0,5 mm, 1 mm, 1,5 mm and 2 mm.

The test showed that the 0,5 mm easily but also the 1 mm thickness could be compromised regarding the robustness and dimensional stability, this if getting bruised or battered, e.g. if it is dropped or bumped on boulders or other things during use or transport. This was not an issue with the 1,5 mm and the 2 mm material thickness, where only superficial scratches occurred during the test.

The 2 mm thickness means more weight and a higher fabrication costs without significant advantages regarding to robustness and dimensional stability when compared to the 1,5 mm material thickness. Therefore the 1,5 mm material thickness is preferred.

### 1.C)

During the development process of the invention, 10 sizes of the square of the tube interior have been tested with the interior size of approx.; 11×11 mm, 12×12 mm, 13×13 mm, 16×16 mm, 17×17 mm, 18×18 mm, 21×21 mm, 22×22 mm, 23×23 mm and 27×27 mm, and it was quickly concluded that a square in the interval of 16×16 mm-23×23 mm (interior) is the most optimal size to use with most types of campfire cookware, since here you must use a shaft with a dia. of approx. 16-23 mm, which 1) has a material strength and stiffness that makes it stable during use both seen in relation to the shaft itself and in relation to the retaining force between the shaft and the connector element, 2) is comfortable to hold in the hands when in use and 3) has a weight that is comfortable to handle during use.

In the case of the other sizes of the square, the shaft will have disadvantages compared to 1), 2) or 3).

### 1.D)

In addition to the ten square sizes mentioned, different lengths of the tube have been tested during the development process and the length have been varied between 20 mm and 150 mm until it was determined that a length in the interval 21-70 mm is the preferred length of the square tube to be integrated into most types of the relevant campfire cookware, as this length ensures good stability when mounted on a suitable shaft or an arbitrary but suitable shaft, in addition this length means the weight of the connector element in itself is in the range 20-70 grams.

A shorter length of the square tube will mean poorer stability after mounting on a shaft and a longer length also means more weight which in total can make transport a bit more difficult, in addition, longer length and more weight will make it more expensive in manufacturing cost. A longer length could thou make the shaft more resistant to the heat and flames from the fire, but the arbitrary shaft is not meant for long term use and could with a little effort easy be replaced if it's getting slightly burnt and compromised thereby.

### 2.E)

During the development process of the invention a single blade were bended to the shape of hook and then connected to the shaft connector element by welding, and there was a focus on the thickness of the hook and the shape of the hook. And it was considered relevant to test a hook capable to hold handles of hanging pots and kettles with a weight less than 500 g (loaded 1500 g.), and the handle width or thickness on that sized cookware is most

often in the range of 4-25 mm. This means a hook gap of approx. 28 mm is suitable, and with a wish of good robustness then a material thickness of 4-5 mm is to be preferred.

### 3.F)

During the development process of the invention, a round tube and a square tube have been tested regarding the outside shape, which include the part of the campfire cookware attachment head that is meant to be the point of contact if it is leaned against a fire pit boulder during the roasting of a food item. And it quickly became clear that the round tube was not optimal, as the outer round profile contributes to the fact that a roasting fork of this type can rotate due to the influence of gravity or accidental bumps and puffs if the spit is placed up against a fire pit boulder during the roasting time. The square tube, on the other hand, provides a much more stable roasting fork, as the four flat sides are individually not affected by gravity or accidental bumps and puffs to a significant degree if a roasting fork of this type is leaned against a fire pit boulder during the roasting time.

### 3.G)

During the development process of the invention, different material thicknesses of the metal rods that make up the blades/prongs have been tested, which have been varied between 2 mm and 10 mm, until it was determined that Ø 3,8-4.5 mm in diameter is the most optimal for this type of roaster attachment head, preferred Ø 4.2 mm, since this material thickness partly 1) provides adequate stiffness in relation to retaining food while at the same time achieving a long life in terms of robustness, these conditions are seen in relation to blades/prongs with a smaller thickness, which will be less rigid and less robust. And partly 2) the weight is kept relatively low with a diameter of 4.2 mm compared to greater material thickness, which is both important in relation to transport and economy, since heavier means possible more difficult transport and more expensive in manufacturing cost. And a greater thickness can also increase the risk of e.g. wieners and other food items to crack or burst and then fall off during roasting.

### 3.H)

During the development process of the invention, different lengths of the blades/prongs have been tested, which have been varied between 1 mm and 40 cm, until it was determined that approx. 14-30 cm in length is the most optimal to use with a tube with the interior square sides between 21×21 mm- 23×23 mm in the square, and that 2-14 cm in length is the most optimal to use with a tube with the interior square sides between 16×16 mm-18×18 mm in the square. Regarding the prong length of 14-30 cm in length with the larger sized squared tube, then this partly 1) allows for roasting/heating many different types of food items in relation to retention and size of the different types. In addition, the 14-30 cm ensure that the attached food can be reach far enough over the fire to achieve satisfactory roasting/heating without the shaft of the roasting fork being exposed to too much heat and thus being unnecessarily damaged, this ratio is seen in relation to shorter prongs which will either be able to hold fewer types of food or that there will be a risk of the shaft begin to burn. And partly 2) the weight is kept relatively low at the length of 14-30 cm seen in relation to longer prongs, which partly has an economic significance, since longer and heavier means higher costs, especially in the manufacturing process, and partly could a longer length than the 14-30 cm especially be important in relation to transport, since a longer length of the roasting fork head than the total of up to 35 cm would mean more difficult transport, for example the most common day trip backpacks (15-28 l.) typically have a height measurement of 32-40 cm. Another disadvantage of a longer length is that the prongs then become less robust and thereby the prongs will have a greater risk of being bent, and finally a longer length of the prongs than the 14-30 cm does not mean anything significant in relation to the number of different types of food, which can be held on the fork. Greater length can, however, also have an effect in relation to the stability of the roaster during use, as the weight of a food item thereby shifts and this could affect the balance negatively.

When it comes to the prong length of 2-14 cm with the smaller sized squared tube, then it is possible to roast a smaller selection and types of food, but in return the weight and volume of the roasting fork heads is considerably smaller, which means that you can easily have one or more roasting fork heads in a pocket in your jacket. Especially the smallest versions, only 5-6 cm long and weighing approx. 25 g, this size for these campfire roasting fork heads take up so little space, and the weight is so small that you easy can keep a pair in a pocket on a jacket. The smallest versions can, for example, be used for wieners and marshmallows and the like.

### 3.I)

During the development process of the invention, different mutual distances between the two prongs have been tested, this on the part of the prongs that is parallel/approximately parallel, which has been varied between 3 mm and 31 mm (measured on the inside between the prongs), until it was determined that a distance of 13-23 mm measured from the outside of one prong to the outside of the other prong, measured perpendicular to the parallel/approximately parallel part of the prongs, measured where this part of the prongs are both on the same horizontal axis opposite each other, in mutual distance is the most optimal (preferably distance 6-14 mm measured on the inside of the prongs when prongs Ø 4.2 mm is used), as this distance allows for the retention of the highest number of different types of food. If the mutual distance between the prongs is made smaller, this could mean, for example, that some types of bread are at risk of being pinched in the middle, and that the perforation hole in pieces of meat may become too large because the fibers of the meat are torn/cut, so there will be a risk of the meat either slides off the prongs or simply spins around on the prongs. And with a greater distance between the prongs will reduce the amount and variety of different types of food to be able to hold and could mean, for example, that flat types of bread, chicken thighs, spareribs and fish will not be able to be clamped down between the prongs sufficiently, resulting in an increased risk of falling off the prongs.

### 3.J)

During the development process of the invention, it was quickly noticed that a form of barbs at the tip of the prongs is conducive to ensuring a more effective retention of a food item on the prongs than on prongs without this design. And the simplest method to make a form of very robust barb like shape at the tips is by pressing the tips of the prongs flat, so that the tip get a rectangular profile which is wider than the prong itself. And based on the desire for robustness combined with efficiency, for prongs Ø 4.2 mm was the following dimensions applicable; approx. 10 mm in length and approx. 2 mm×6.6 mm in profile of the flattened part and then the tip was grinded and sharpened on the outermost 7 mm, giving the tip an approximate triangular shape, a spear point with the effect as of having two barbs each, which in particular is approx. 1.2 mm wider than the single prong itself. A smaller width than approx. 1.2 mm will have less effect as barb, while a larger width, with this method, will mean a less robust tip, as the material thickness in the rectangular profile then would be very thin.

### 3.K)

The number of prongs may be relevant in relation to the number of different food types and in relation to functions that the cookware may have. Under section 3.I) it was concluded that a specific mutual distance between the two prongs was an important factor in relation to being as versatile as possible in relation to the types and number of different foods. It may therefore be relevant to determine whether more prongs can make a significant difference both in terms of number but also, for example, the shape these more prongs could have.

A test where a third prong with the same length as the first two was connected by welding to the connector element on the interior side and it was determined that there was no significant difference in relation to the number of food items, however some food items such as a potato could be held better fixed on the roasting fork with three prongs, and it worked best when the three prongs of the roasting fork had a length in the range of 4-10 cm. A fourth or more prongs made no difference in this context.

Then it was tested whether a shorter third prong, which was, for example, at the same time bent into the shape of a hook, could be beneficial. And it was determined that, for example, the hook could more securely hold the handle of a kettle or small hanging pot than a straight prong could, and that the hook could also be used to hold an organic piece of string, such as hemp, which could then be used to spin around a food item placed on the two long prongs of the roasting fork and thereby ensure greater retention, this could be relevant, for example with a fish fillet or something else with a porous consistency when heated.

Then a test was made in which 8 prongs with a length in the range of 4-10 cm and an individual thickness of about 2 mm were connected by welding with a connecting element, where the prongs were placed on the outside of the connecting element on two of the sides of the square tube, which were parallel to each other.

And it became clear relatively quickly that a smaller number of foods could be retained than with 2-3 prongs placed and fixed inside the square tube, however, certain foods such as French fries and other foods could be held in relatively thin strips, which could not be held securely by the roasting fork with other dimensions and a lower numbers of prongs and locations of the prongs.

### 3.L)

A location of the prongs attached externally to the square tube profile and a location with the prongs attached inside the tube, both in the longitudinal direction of the tube, this will make the campfire roasting fork attachment head measuring less than 36 mm on the widest part of the prongs, measured on the outside perpendicular to the longitudinal direction of the tube and the prongs and measure on a part of the prongs being parallel to each other. The external location makes the roasting fork less robust and less stable if it has to being leaned against a boulder during the roasting of a food item, in addition it has a poorer aesthetic appearance, as the welds between the prongs and the square-prism shaped part will be completely visible, the visible welds can also make cleaning difficult. The internal attachment of the prongs, on the other hand, will make the utensil more robust, more stable during roasting and less difficult to clean after use, as well as having a better aesthetic expression with the internal welds, which are almost invisible when the fork attachment head is mounted on a shaft.

The interior attachment of the prongs is preferred to be in the longitudinal direction of the square tube and this in the corners and by using two diagonal corners makes it very robust and works best, but is not absolutely necessary. And if to achieve the preferred mutual distances between the two prongs mentioned in J), the prongs are therefore bent convexly and concavely partly at the exit from the tube and partly approx. 3 cm further towards the tips. The two bends must be of a size that makes the two prongs become parallel/approximately parallel as mentioned in J).

A third prong can be placed in one of the two free internal corners or on the exterior side of the tube and a fourth or more prongs can be placed where it makes sense, this however, without compromising the interior square tube's ability to hold an arbitrary but suitable branch of wood.

There can also be a combination of internal and external attachment of the prongs, however the prongs should always be attached to the connector element in such a way that the prongs have a direction outwards from one end of the connector element, so that the maximum distance between the prongs is less than 31 mm, measured from the inside of one prong to the inside of another prong, measured perpendicular to the prongs on a parallel part of the prongs, where the prongs are on the same horizontal axis opposite each other.

### 4.M)

Testing of the shaft connecting method-In terms of patents, it would be appropriate to test how firmly an arbitrary but suitable branch of wood can be fixed inside a connector element with a square tube profile without the use of tools or a fastening device, and it can also be seen as good scientific practice to explain how you can get an apparently round branch of wood to fit and be fixated inside a tube with a square/approximately square tube profile; this if the apparently round branch is e.g. slightly oval seen in a perpendicular cross section, and that you insert the widest part of the oval branch into one of the diagonals and then twist the branch 30-45 degrees around inside the tube. Thereby, the wider part of the branch will going to press against the inner side of the tube and the branch will be fixed relatively firmly by friction, and this is how an arbitrary but suitable shaft made of wood can be inserted and fixated in a connector element with a square tubular interior without the use of tools or a fastening device (branches of wood with other shapes can work as well). This shaft connecting method is now named; the Stone-Deer Principle.

The test was performed in relation to retaining force, where a shaft connector element in one of the preferred embodiment 5 cm in length and 22×22 mm in the interior square was used and some branches of hazel and birch approx. 22 mm dia. in one end of the branches were selected and used as arbitrary but suitable shafts made of wood. A hook attachment head (FIG. 9) were used for this test.

Which shape of an arbitrary but suitable branch did work as a stable shaft with satisfactory retention capability: M1) a slightly oval profile (cross sectional) of the end to be inserted, M2) a side branch collar 1-4 cm from the tip of the end to be inserted, M3) a form of a curvature 1-4 cm from the tip of the end to be inserted and M4)=any combination of M1), M2) and M3).
A suitable branch manipulated e.g. with a knife into an approx. shape of M1), M2), M3) or M4) works as well.

When testing an average arbitrary but suitable branch M1), M2), M3) or M4) then it took a direct pulling force (lift) of +25 kg to separate the branch from the shaft connector element, and with a snug fit selected arbitrary but suitable branch M4), it took a direct pulling force (lift) of +50 kg to separate the branch from the connector element.

Something to consider is, that some kind of a small tap or knob on the interior side of the tube e.g. in the center of one or more of the square's sides could make the retaining force even higher, albeit this is not considered necessary for everyday use. Something also to think about is that such a small tap or knob inside a round tube could actually help to get an oval branch or a branch with a curvature to be fixated inside a round tube as well.

And with an optional possibility to drill e.g. a small hole in one side of the tube to be able to insert a fastening device e.g. a screw, then a shaft can be mounted for long term use if chosen so.

### IN THE FIGURES

FIG. 1 shows a campfire roasting fork attachment head (3) with two prongs (1) according to the invention, in perspective.

FIG. 2 shows a campfire roasting fork attachment head (3) with two prongs (1) according to the invention, in perspective.

FIG. 3 shows a campfire roasting fork attachment head (3) with two prongs (1) according to the invention, in perspective.

FIG. 4 shows a campfire roasting fork attachment head (3) with two prongs (1) according to the invention, in perspective.

FIG. 5 shows a campfire roasting fork attachment head (3) with three prongs (1) according to the invention, in perspective.

FIG. 6 shows a campfire roasting fork attachment head (3) with three prongs (1) according to the invention, in perspective.

FIG. 7 shows a campfire roasting fork attachment head (3) with two prongs (1) according to the invention, in perspective.

FIG. 8 shows a campfire cooking equipment shaft connector element (2) from a campfire roasting fork attachment head with an oval branch of wood (20) inside the square tube part of the connector element, in a perpendicular cross-section.

FIG. 9 shows a campfire cooking equipment shaft connector element (2) with one hook-shaped prong (1), in perspective.

### FIGURE DESCRIPTION

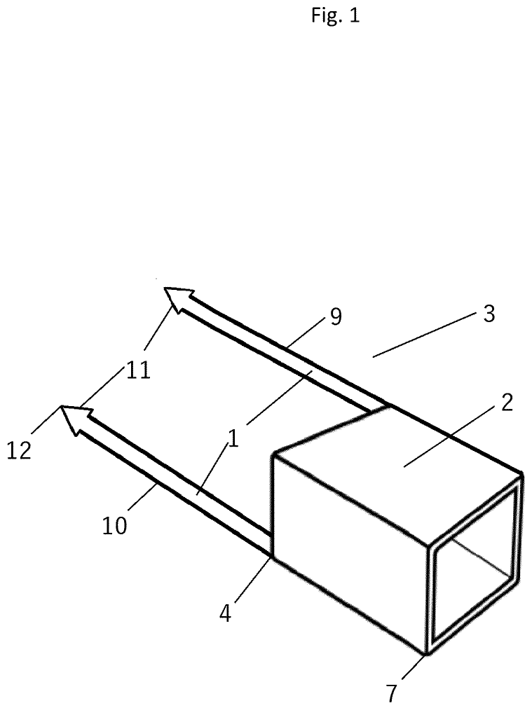

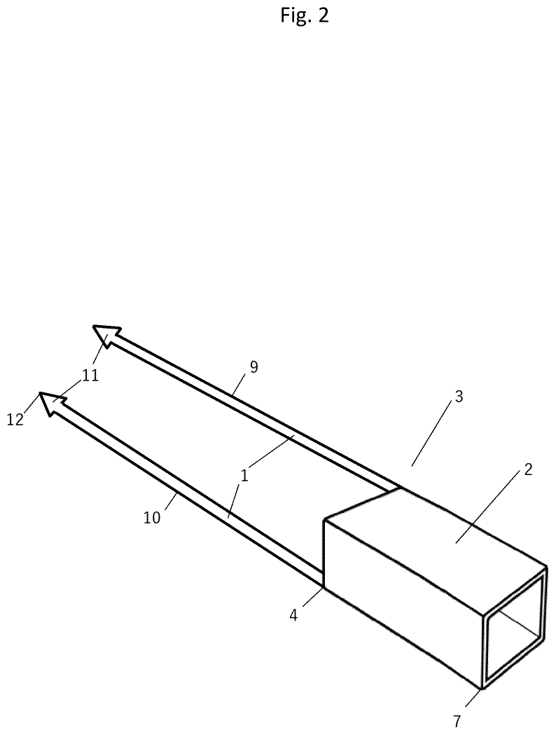

FIG. 1-4 common ground; The campfire roasting fork attachment heads each have a part (2), that best can be described as having a squared prism-shaped exterior.

FIG. 1-4 each shows a campfire roasting fork attachment head (3), with 2 prongs (1) according to the invention, with a part of the 2 prongs placed on the interior side of the campfire cooking equipment shaft connector element (2) in two diagonal corners of the connector elements square tube and with a relatively small connecting area (6) between the welded parts . The lengths of the prongs (1) are in the range 4-30 cm, measured between the tips (12) of the prongs to the point of the edge (4) of the connector element (2) which is closest to the tips (12). The two prongs (1) have an equal mutual distance between the prongs on a significant part of the prongs, and this distance is less than approx. 23 mm measured in a straight line between the outside of one prong (10) to the outside of the other prong (9), measured perpendicular to the parallel/approximately parallel part of the prongs, measured where this part of the prongs are both on the same horizontal axis opposite each other.

The length of the campfire cooking equipment shaft connector element (2) is in the range 22-50 mm measured in the longitudinal direction of the connector element (edge 4,7), and the interior square sides are each in the range 12-24 mm.

And the length of the roasting fork attachment head (3) is less than 45 cm measured in a straight line between the tip of the longest tip (12) and to the edge of the connector element (7) with the largest distance to the tip (12).

The tip of each prong is having a triangular shape (11) which is wider at the base of the triangle and which is also wider than the prong itself, this kind of shape can have the effect similar to barbs.

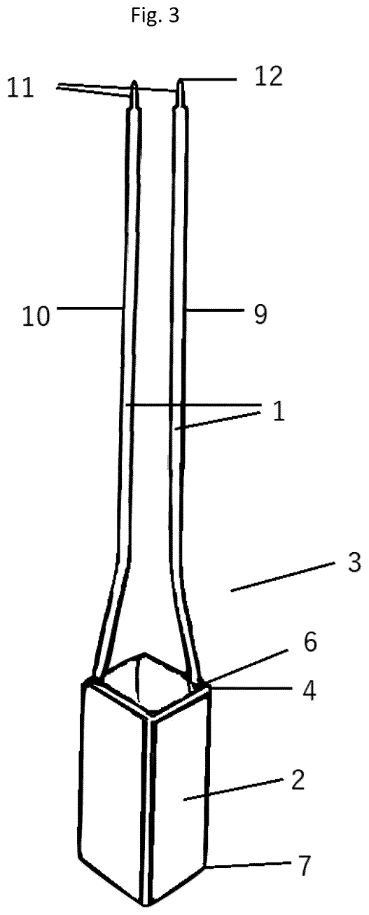

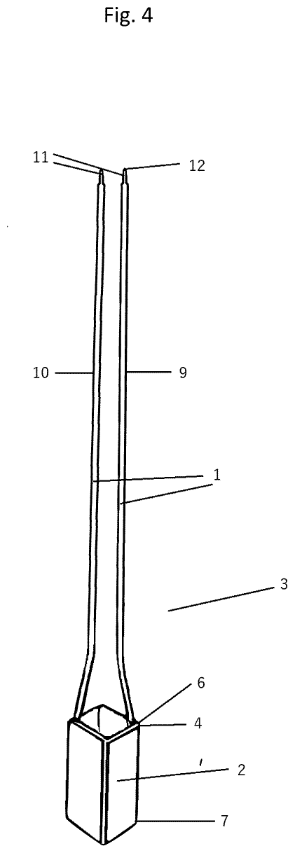

And it appears that the connector element is positioned so that a shaft can be inserted into the tube part of the connector element without any particular difficulty and without compromising the possibility to fixate a food item to the prongs. FIG. 3-4 The prongs (1) are at their attachment to the shaft connector element and again after approx. 10% of their length, bent convex and concave so that a parallel/approximately parallel and specific smaller mutual distance between the prongs is formed on the outer part towards the tips of the prongs than is seen at the inner part of the prongs towards the attachment to the connector element. This smaller distance is measured to be less than 23 mm, measured in a straight line between the outer sides of the two prongs (9)(10) and measured perpendicular on the two prongs when the two prongs both are on the same horizontal axis.

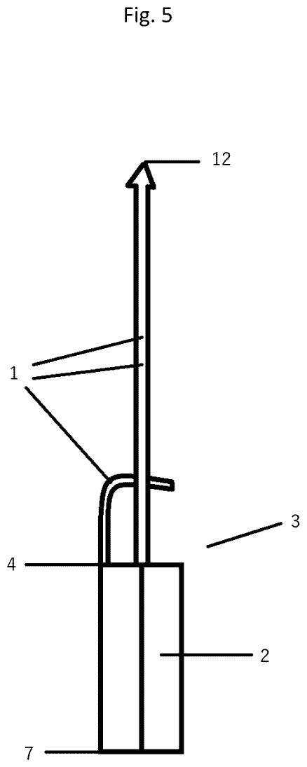

FIG. 5 shows a campfire roasting fork attachment head (3), with three prongs (1) according to the invention from the side with the two longest prongs on the same vertical axis. And with a part of each of the three prongs placed on the interior side of the campfire cooking equipment shaft connector element (2). Two of the prongs are placed in two diagonal corners and one is placed in one of the two other corners, two of the prongs are approx. parallel on most of their length, and the third prong is shorter than the two others. This shorter prong is bended convex/concave on a part of the prong and the shape appear to be hook like and it appears that the hook-shaped prong is positioned so that a shaft can be inserted into the connector element without any particular difficulty and without compromising the hooks capability to hold a handle of a kettle or a hanging pot. The length of each of the prongs is less than 35 cm, measured in a straight line between the tips of the longest prong (12) to the point of the edge of the connector element which is closest to the tips (4). And the length of the roasting for attachment head is less than 45 cm measured in a straight line between the tips of the prongs (12) and to the edge of the connector element (7) with the longest distance to the tips of the prongs (12).

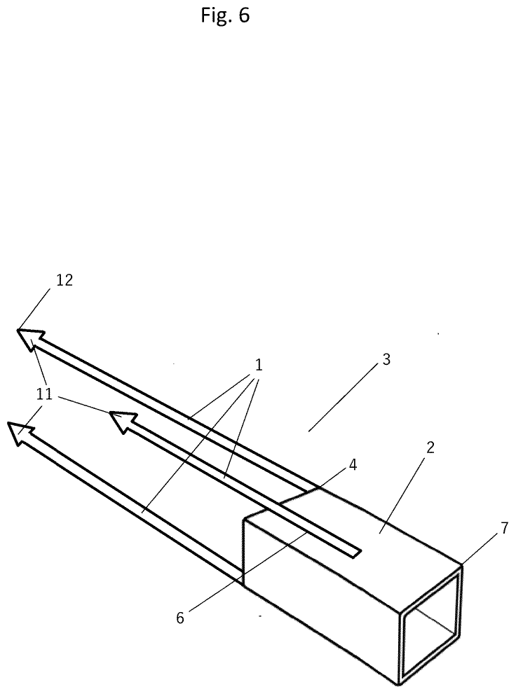

FIG. 6 shows a campfire roasting fork attachment head (3), with three prongs (1) according to the invention in perspective, with a part of one or more of the prongs placed and connected by welding on the exterior side of the campfire cooking equipment shaft connector element (2). The connecting area (6) between the welded parts of the prongs are approx. parallel to the length of the connector element and the lengths of the three prongs are different to each other, the three prongs are all less than 35 cm in length, measured from the tip of the longest prong (12) to the point of the edge of the connector element (4) which is closest to the tip (12). The length of the roasting fork attachment head is less than 45 cm, measured from the tip of the longest prong (12) and to the edge of the connector element (7) with the largest distance to the tip of the longest prong (12). The tip of each prong is having a triangular shape (11) which is wider at the base of the triangle and which is also wider than the prong itself, this kind of shape can have the same effect similar to barbs.

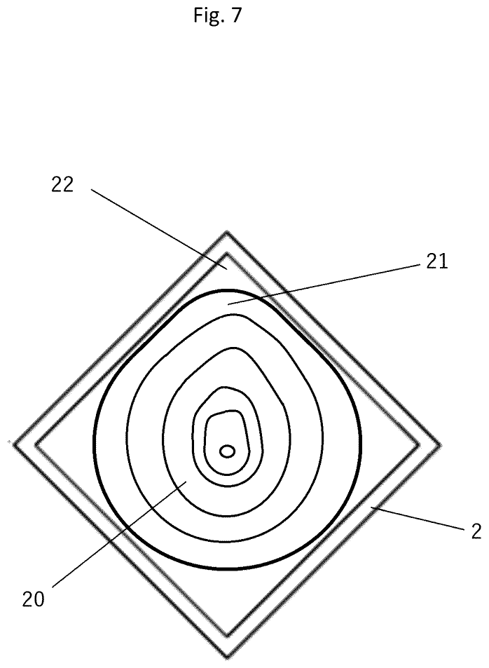

FIG. 7 shows a campfire roasting fork attachment head (3), with two prongs (1) according to the invention in perspective, with the two prongs placed and connected on the exterior side of the shaft connector element, the two prongs are placed at two diagonal corners, and this gives the maximum distance between two prongs at the points where they are emerging from the edge (4). This maximum distance between the two prongs is less than 36 mm, when a connector element 25 mm/1 inch in the exterior square are used, and it is measured at the emerging point in a straight line between the inner sides of the two prongs (13, 14) and measured perpendicular to the two prongs when the two prongs both are on the same horizontal axis.

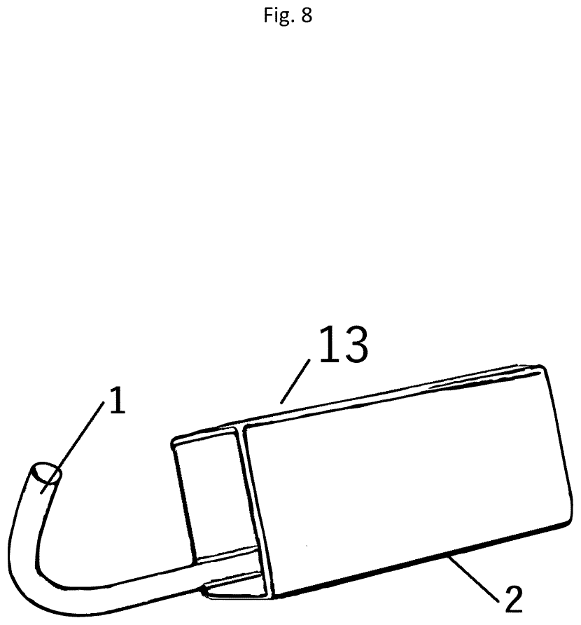

FIG. 8 shows a perpendicular cross-section of a campfire cooking equipment shaft connector element (2) with a slightly oval piece of wood (20) fitted inside the connectors'squared tube, it quite clearly appears that the widest part (21) of the oval shaped branch of wood is placed in one of the diagonal corners (22) of the square tube.

FIG. 9 shows a campfire cooking equipment shaft connector element (2) as an integrated part of a hook attachment head (15), it appears that the hook-shaped prong (1) is positioned so that a shaft can be inserted into the connector element without any particular difficulty and without compromising the hooks capability to hold a handle of a kettle or a hanging pot.

### REALIZATION OF THE INVENTION IN PRACTICE

A realization of a campfire roasting fork attachment head, in one of the preferred embodiment, requires a TIG welding apparatus, e.g. a piece of squared profile tube made of stainless steel approx. 5 cm in length and 22 mm×22 mm in the square measured on the interior sides of the tube, and then two or three prongs shaped according to the invention. The prongs are preferred placed e.g. in two or three of the interior square tube corners pointing out from one end of the tube and then connected by welding to the tube. As an option the tips of the prongs can either before or after the welding, be shaped triangular to get the effect similar to barbs. After welding the now realized campfire roasting fork attachment head is then sanded and polished and it will be ready to use.

### SUMMARY

The invention relates to a campfire cookware with form as a fork for use over an open fire outdoors, a roasting fork. More specific, a roasting fork attachment head (3) consisting of a part which is a shaft connector element (2) with a square tubular interior and with two or more prongs (1). The Campfire roasting fork attachment head (3) is intended for mounting on or with an arbitrary but suitable shaft (handle part), and is thereby intended to function and be used handheld under the process of roasting/heating food.

There are disadvantages to existing campfire cookware for food preparation over an open fire outdoors, as existing cookware are individually often targeted at specific types of food, and in addition, the existing cookware are often either heavy, long and/or generally difficult to handle during transport, use or cleaning after use.

Overall, the provision of a new designed campfire roasting fork attachment head according to the invention will alone be able to cover a large part of the need for the preparation of different types of food, where with traditional cookware, 2, 3 or 4 different types have otherwise had to be used. In addition, the campfire roasting fork attachment head according to the invention is robustly constructed, easy to; use and clean and has a long service life without significant maintenance, and will make transport a lot easier regarding the weight and volume partly because a shaft most of the time is no longer necessary to bring along and particularly because less cookware is needed.

1. A campfire roasting fork attachment head (3) made of steel, comprising: a minimum of two prongs (1) connected by welding with a shaft connector element (2) which in its longitudinal direction has a square/approximately square tubular interior with an exterior side and an interior side, and where the interior square/approximately square tube sides of the connector element measuring in the range of 12-24 mm in the square, characterized in, that a total length of the shaft connector element (2) is in the range of 21-150 mm measured in a straight line along the exterior side of the shaft connector element between two edges (4,7) and that two or more prongs (1), each prongs (1) can have a different length, are placed in the longitudinal direction of the shaft connector element and connected either on the interior side and/or the exterior side of the shaft connector element, and thereby emerge from one edge (4) of the shaft connector element (2), and where two or more prongs are mutually parallel/approx. parallel for a part of minimum 20 mm of their length with a maximum distance of 35 mm between two prongs on this mutually parallel/approx. parallel part, measured in a straight line between the outer sides of these prongs and perpendicular to these prongs, where these prongs both are on the same horizontal axis and opposite to each other, and where each of the prongs on their mutually parallel/approx. parallel part have the same material thickness both vertically and horizontally in the range of 2-5 mm measured in a perpendicular cross-section of each prong.

2. A campfire roasting fork attachment head as claimed in claim 1 characterized in, that the parallel/approximately parallel part of the prongs is in the range of 20-350 mm measured in a straight line along the prongs, and where a total length of the campfire roasting fork attachment head (3), measured in a straight line between an outermost end of a tip (12) of the longest prong (1) and to the edge (7) of the shaft connector element (2) with the largest distance to the tip (12), is in the range of 40-450 mm.

3. A campfire roasting fork attachment head according to claim 2 characterized in, that two or more of the prongs (1) on their parallel/approximately parallel part have an equal mutual distance between two prongs in the range of 13-23 mm, measured between the outside of one prong to the outside of the other of the two prongs, measured perpendicular to the parallel/approximately parallel part of these two prongs (1) and where these parts of the prongs are both are on the same horizontal axis and opposite each other.

4. A campfire roasting fork attachment head according to claim 3 characterized in, that one or more of the prongs (1) are connected to the interior side of the shaft connector element (2).

5. A campfire roasting fork attachment head according to any of claims 1-2-3 and 4 characterized in, that a part of the shaft connector element (2) has an approx. square prism shaped exterior.

6. A campfire roasting fork attachment head according to any of claims 1-2-3-4 and 5 characterized in, that one or more of the prongs (1) are bent either convexly and/or concavely on a part of each specific prong.

7. A campfire roasting fork attachment head, according to any of claims 1-2-3-4-5 and 6 characterized in, that the campfire roasting fork attachment head (3) is mounted on a shaft.

8. A campfire roasting fork attachment head, according to any of claims 1-2-3-4-5 and 6 characterized in, the connector element (2) further comprises a hole in one side of the sides of the square tube.

9. Use of the campfire roasting fork attachment head, according any of claims 1-8 by holding it by hand with an arbitrary but suitable wooden shaft for example a slightly oval wooden shaft (20), which can be inserted and fixated in the tube part of the shaft connector element without any use of tools or fixated by insert of a fastening device e.g. a screw, in the hole in the side of the tube, if a shaft is chosen to be mounted for long term use.
